(19) United States
(12) Patent Application Publication
(10) Pub. No.: US 2009/0201794 A1
(43) Pub. Date: Aug. 13, 2009

(54) MULTIPLEXING DEVICES OVER SHARED RESOURCES

(75) Inventors: Tao Luo, San Diego, CA (US); Juan Montojo, San Diego, CA (US); Xiaoxia Zhang, San Diego, CA (US)

Correspondence Address: QUALCOMM INCORPORATED, 5775 MOREHOUSE DR., SAN DIEGO, CA, 92121, US

(73) Assignee: QUALCOMM, Incorporated, San Diego, CA (US)

(21) Appl. No.: 12/366,010

(22) Filed: Feb. 5, 2009

Related U.S. Application Data
(60) Provisional application No. 61/027,143, filed on Feb. 8, 2008.
(60) Provisional application No. 61/034,227, filed on Mar. 6, 2008.

(51) Int. Cl. H04J 11/00

(52) U.S. Cl. 370/206

(57) ABSTRACT

Systems and methodologies are described that facilitate transmitting and receiving signals over I and Q branches of a communication channel to mitigate potential I/Q imbalance. In particular, a device can transmit a signal over the I and Q branches to distribute transmission power substantially evenly for a given channel. The device can demodulate the data with a code or matrix having real and complex modifiers resulting in an I and Q branch signal for transmission. Where the channel has multiple resources, the device can alternate or transmit over the I branch in one resource and the Q branch in another resource for a given signal to distribute power. Also, the device can apply a complex scrambling code to distribute a signal over both the I and Q branches. The device can also use QPSK or higher order modulation to send the signals meant for the same user.

### CROSS-REFERENCE TO RELATED APPLICATIONS

This application claims the benefit of U.S. Provisional Patent application Ser. No. 61/027,143 entitled “METHODS OF MULTIPLEXING USERS SHARING THE SAME RESOURCE” which was filed Feb. 8, 2008 and U.S. Provisional Patent application Ser. No. 61/034,227 entitled “METHODS OF MULTIPLEXING USERS SHARING THE SAME RESOURCE” which was filed Mar. 6, 2008. The entireties of the aforementioned applications are herein incorporated by reference.

### BACKGROUND

I. Field

The following description relates generally to wireless communications, and more particularly to multiplexing multiple device communication over one or more shared resources.

II. Background

Wireless communication systems are widely deployed to provide various types of communication content such as, for example, voice, data, and so on. Typical wireless communication systems may be multiple-access systems capable of supporting communication with multiple users by sharing available system resources (e.g. bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

Devices in wireless communications can transmit and receive signals over shared resources. For example, one or more multiplexing technologies can be utilized to combine signals over the resource, such as frequency division multiplexing (FDM), time division multiplexing (TDM), code division multiplexing (CDM), orthogonal FDM (OFDM), etc. The devices can utilize binary phase shift keying (BPSK) to achieve orthogonality over one or more resources and in-phase/quadrature (I/Q) multiplexing to expand capacity of the resources. This, in turn, desirably increases the number of supported signals over the resources resulting in improved communication throughput over the resources and related wireless communication network. Substantial difference in transmit power over the I and Q branches, however, can cause I/Q imbalance leading to undesirable results when demultiplexing received signals.

### SUMMARY

The following presents a simplified summary of one or more embodiments in-order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating transmitting one or more individual signals, utilizing in-phase/quadrature (I/Q) multiplexing, over both the I and Q branches to more evenly spread transmit power. In one example, a portion of a given signal can be transmitted over an I branch with the remainder transmitted over a Q branch. In this regard, for example, transmission power for the given signal is substantially similar on both the I and Q branches. In another example, a signal repeated multiple times can alternate between transmitting over the I and Q branches at one or more repetitions to provide more balanced I/Q multiplexing.

According to related aspects, a method for modulating data for I/Q multiplexing is provided. The method can include receiving configuration information related to a wireless communication channel. The method can also include modulating data into one or more signals according to the configuration information and transmitting the signals over an I and a Q branch of the communication channel.

Another aspect relates to a wireless communications apparatus. The wireless communications apparatus can include at least one processor configured to create a signal for transmission based at least in part on received data and distribute the signal over an I and a Q branch of a communication channel. The processor is further configured to transmit the signal over the communication channel using the I and Q branches. The wireless communications apparatus also comprises a memory coupled to the at least one processor.

Yet another aspect relates to a wireless communications apparatus that facilitates mitigating I/Q imbalance in transmitting wireless communication signals. The wireless communications apparatus can comprise means for generating a signal based at least in part on data to be transmitted and means for distributing the signal over an I and a Q branch of a communications channel. The wireless communications apparatus can additionally include means for transmitting the signals of the I and Q branches of the communications channel.

Still another aspect relates to a computer program product, which can have a computer-readable medium including code for causing at least one computer to determine configuration information related to a communication channel. The computer-readable medium can also comprise code for causing the at least one computer to modulate data into one or more signals divided over an I and a Q branch of the communication channel. Moreover, the computer-readable medium can comprise code for causing the at least one computer to transmit the signals over the I and Q branches of the communication channel.

Moreover, an additional aspect relates to an apparatus. The apparatus can include a channel resource determiner that receives configuration information related to one or more communication channels. The apparatus can further include a data modulator that generates a signal for transmission over an I branch and a signal for transmission over a Q branch of the channel based at least in part on the configuration information and a transmitter that transmits the signals over the I and Q branch.

According to a further aspect, a method that facilitates evaluating communication channels based on a signal multiplexed over an I and Q branch is provided. The method includes receiving a multiplexed signal from a plurality of wireless devices related to a communication channel and separating the multiplexed signal to a portion received at an I branch and a portion received at a Q branch. The method also includes demodulating part of the portion received at the I branch and part of the portion received at the Q branch to produce data transmitted by one of the plurality of wireless devices over the communication channel.

Another aspect relates to a wireless communications apparatus. The wireless communications apparatus can include at least one processor configured to receive a multiplexed signal from a plurality of wireless devices over a communication channel and demultiplex the multiplexed signal to determine a plurality of signals each related to at least one of the plurality of wireless devices transmitted over an I and a Q branch of the communication channel. The processor is further configured to demodulate at least one signal transmitted over the I branch and one signal transmitted over the Q branch to determine data transmitted by at least one of the plurality of wireless devices. The wireless communications apparatus also comprises a memory coupled to the at least one processor.

Yet another aspect relates to a wireless communications apparatus for receiving I/Q multiplexed signals. The wireless communications apparatus can comprise means for receiving multiplexed signals related to a communication channel over an I and a Q branch. The wireless communications apparatus can additionally include means for demultiplexing the multiplexed signals for the I and the Q branches to produce a plurality of signals from a device transmitted over the branches and means for demodulating at least one device signal from the I branch and one device signal from the Q branch to receive data transmitted by the device.

Still another aspect relates to a computer program product, which can have a computer-readable medium including code for causing at least one computer to receive a multiplexed signal from a plurality of wireless devices related to a communication channel. The computer-readable medium can also comprise code for causing the at least one computer to separate the multiplexed signal to a portion received at an I branch and a portion received at a Q branch. Moreover, the computer-readable medium can comprise code for causing the at least one computer to demodulate part of the portion received at the I branch and part of the portion received at the Q branch to produce data transmitted by one of the plurality of wireless devices over the communication channel.

Moreover, an additional aspect relates to an apparatus. The apparatus can include a receiver that receives a multiplexed signal from a plurality of wireless devices related to a communication channel and a demultiplexer that demultiplexes an I and a Q branch of the communication channel to yield a plurality of signals transmitted on both the I and the Q branch. The apparatus can further include a demodulator that demodulates at least one of the plurality of signals transmitted on the I branch and at least one of the plurality of signals transmitted on the Q branch to determine data transmitted by one of the plurality of wireless devices.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example device for modulating signals over an I and Q branch to mitigate I/Q imbalance.

FIG. 3 is an illustration of an example communications apparatus for employment within a wireless communications environment.

FIG. 4 is an illustration of an example wireless communications system that effectuates transmitting and receiving signals over an I and Q branch.

FIG. 5 is an illustration of an example methodology that facilitates transmitting signals over an I and Q branch according to received configuration information.

FIG. 6 is an illustration of an example methodology that facilitates processing signals received over an I and Q branch.

FIG. 7 is an illustration of an example mobile device that modulates and/or scrambles signals for transmission over an I and Q branch.

FIG. 8 is an illustration of an example system that assigns channel configurations and receives signals transmitted over an I and Q branch.

FIG. 9 is an illustration of an example wireless network environment that can be employed in conjunction with the various systems and methods described herein.

FIG. 10 is an illustration of an example system that mitigates I/Q imbalance by distributing signal transmission over an I and Q branch.

FIG. 11 is an illustration of an example system that receives signals transmitted over an I and Q branch and determines device data from the signals.

### DETAILED DESCRIPTION

Various embodiments are now described with reference to the drawings, wherein like reference numerals are used to refer to like elements throughout. In the following description, for purposes of explanation, numerous specific details are set forth in-order to provide a thorough understanding of one or more embodiments. It may be evident, however, that such embodiment(s) can be practiced without these specific details. In other instances, well-known structures and devices are shown in block diagram form in-order to facilitate describing one or more embodiments.

As used in this application, the terms “component,” “module,” “system,” and the like are intended to refer to a computer-related entity, either hardware, firmware, a combination of hardware and software, software, or software in execution. For example, a component can be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets (e.g., data from one component interacting with another component in a local system, distributed system, and/or across a network such as the Internet with other systems by way of the signal).

Furthermore, various embodiments are described herein in connection with a mobile device. A mobile device can also be called a system, subscriber unit, subscriber station, mobile station, mobile, remote station, remote terminal, access terminal, user terminal, terminal, wireless communication device, user agent, user device, or user equipment (UE). A mobile device can be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem. Moreover, various embodiments are described herein in connection with a base station. A base station can be utilized for communicating with mobile device(s) and can also be referred to as an access point, Node B, evolved Node B (eNode B or eNB), base transceiver station (BTS) or some other terminology.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

The techniques described herein may be used for various wireless communication systems such as code division multiple access (CDMA), time division multiple access (TDMA), frequency division multiple access (FDMA), orthogonal frequency division multiple access (OFDMA), single carrier frequency domain multiplexing (SC-FDMA) and other systems. The terms “system” and “network” are often used interchangeably. A CDMA system may implement a radio technology such as Universal Terrestrial Radio Access (UTRA), CDMA2000, etc. UTRA includes Wideband-CDMA (W-CDMA) and other variants of CDMA. CDMA2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) is an upcoming release that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). CDMA2000 and UMB are described in documents from an organization named “3rd Generation Partnership Project 2” (3GPP2). The techniques described herein can also be utilized in evolution data optimized (EV-DO) standards, such as 1xEV-DO revision B or other revisions, and/or the like. Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

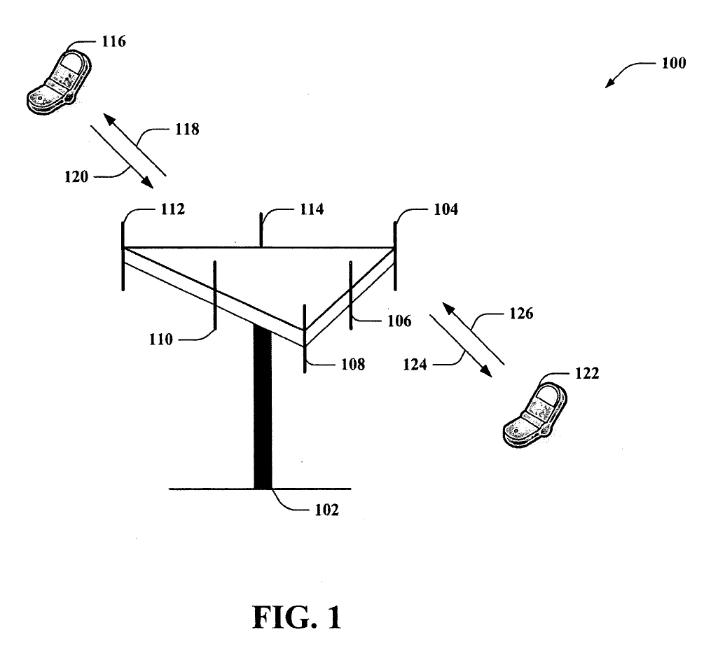

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology (not shown).

According to an example, system 100 can be a multiple-input multiple-output (MIMO) communication system. Further, system 100 can utilize substantially any type of duplexing technique to divide communication channels (e.g. forward link, reverse link, . . . ) such as FDD, FDM, TDD, TDM, CDM, and the like. In addition, communication channels can be orthogonalized to allow simultaneous communication with multiple devices over the channels; in one example, OFDM can be utilized in this regard. The mobile devices 116 and 122 can modulate data into one or more communication signals over one or more communication channels using binary phase shift keying (BPSK), quadrature phase shift keying (QPSK), M-phase-shift keying (M-PSK), etc. to ensure orthogonality over the channel. The mobile devices 116 and 122 can multiplex the modulated signals, using in-phase/quadrature (I/Q) multiplexing for example, and transmit the signals to the base station 102 and/or one another (not shown). Such I/Q multiplexing increases the capacity of a communication channel by allowing communication over each of the two branches, which are rotated with respect to one another to mitigate interference. Signals transmitted over the I and Q branches, however, can experience interference from the other branch due to imbalance in the transmit power of signals over the branch.

To mitigate I/Q imbalance, the mobile devices 116 and 122 can multiplex given modulated signals such that at least one signal is transmitted over both the I and Q branches. In one example, the mobile devices 116 and 122 can transmit a portion of a modulated signal (e.g., substantially half of the signal) over the I branch and transmit the remaining portion over the corresponding Q branch. This substantially evens out power over the branches. In another example, where a modulated signal is transmitted in a signal group, a signal in the group can be alternated between the I and Q branches in the multiple transmission. It is to be appreciated that signals from the base station 102 can be similarly modulated and/or multiplexed. In addition, the mobile devices 116 and/or 122 or base station 102 can communicate with a similar device in a peer-to-peer or ad hoc mode, as mentioned, utilizing the multiplexing and/or modulation functionalities described herein.

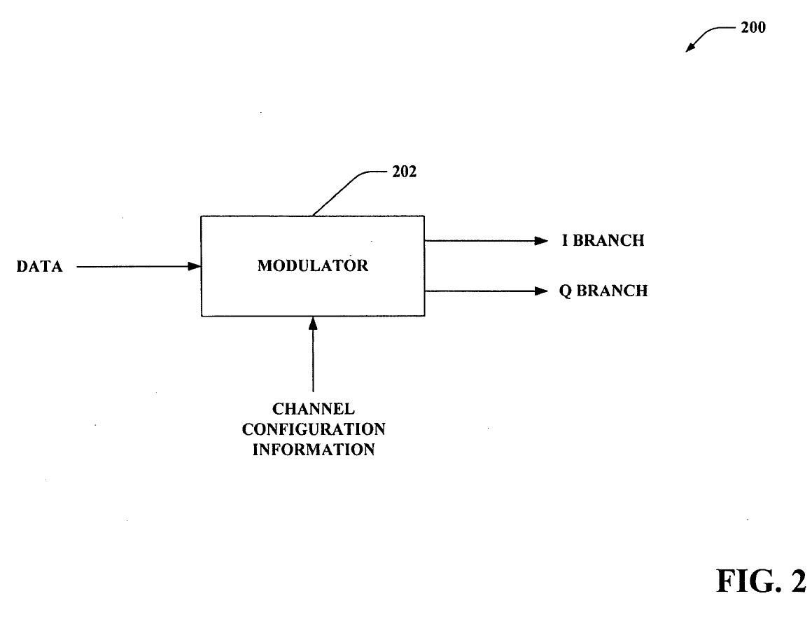

Referring now to FIG. 2, a system 200 that facilitates spreading data over an I and Q branch for subsequent transmission is shown. The system 200 includes a modulator 202 that prepares data for transmission as a signal over a wireless communication network. The modulator 202, as depicted, can receive data to be transmitted as input along with channel configuration information. The channel configuration information can relate to, for example, channel resources assigned by a wireless device, information regarding transmitting data over the channel, such as codes for modulating, scrambling, and/or multiplexing the data, transmission intervals, repeat/request information, and/or the like. According to the channel configuration information, the modulator 202 can spread the data over an I and Q branch of a related antenna (not shown) for transmission.

Received channel configuration information can specify one or more instructions for spreading data over the I and Q branches. In one example, channel configuration information can comprise codes or matrices, such as orthogonal or quasi-orthogonal codes (including Walsh codes, for example), M matrices, and/or other such codes/matrices having good correlation properties. It is to be appreciated that quasi-orthogonal codes can refer to code matrices whose row or columns are orthogonal, or any other set of codes that exhibit partial orthogonality. The modulator 202 can utilize the codes to transform the data into a signal for transmission. In one example, the codes, when applied to the data, can create a signal on the I branch and a 90-degree phase rotated signal for the Q branch. According to one example, the code can facilitate creating the signal such that substantially one half of the signal power related to the data is on the I branch with the other half on the Q branch. This can mitigate I/Q imbalance, as described.

In another example, the channel configuration information can relate to providing signal repeating such that a signal created by the modulator 202 can be transmitted multiple times. This can occur, for example, in automatic repeat/request (ARQ) configurations, hybrid ARQ (HARQ) configurations, and/or the like, where there can be multiple partial time and frequency resources, such as control channel elements (CCE), for a given channel. Thus, in one example, according to the channel configuration information, the modulator 202 can transmit the signal over the I branch and repeat the signal over the Q branch. It is to be appreciated that more than one repetition can be specified by the configuration, and the signal can alternate between the I and Q branches or otherwise transmit at least once on each branch, in one example. Additionally, for example, the channel configuration information can relate to applying a complex scrambling code such to cause transmission of at least a portion of the signal over the Q branch where the signal was previously scheduled for I branch transmission (and/or vice versa). Moreover, in an example, the modulator 202 can support communicating with a device over MIMO channels with multiple transport blocks, such as an uplink single-user (SU) MIMO channel. In this regard, the modulator 202 can modulate signals relating to multiple physical HARQ indicator channels (PHICH) each over at least one I and at least one Q branch to mitigate I/Q imbalance in supporting the SU-MIMO channel.

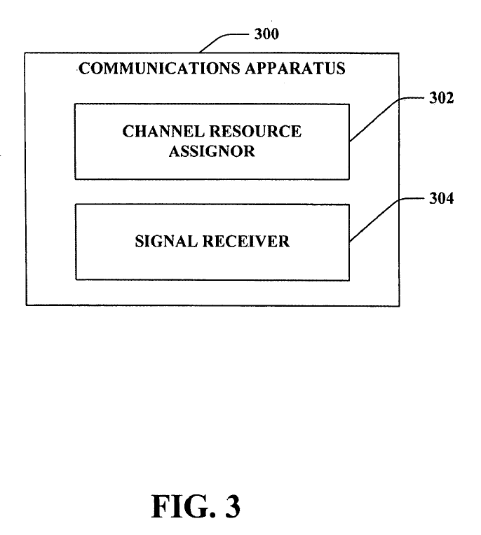

Turning to FIG. 3, illustrated is a communications apparatus 300 for employment within a wireless communications environment. The communications apparatus 300 can be a base station or a portion thereof, a mobile device or a portion thereof, or substantially any communications apparatus that receives data transmitted in a wireless communications environment. The communications apparatus 300 can include a channel resource assignor 302 that allocates one or more channel resources to one or more wireless devices (not shown) and a signal receiver 304 that receives one or more signals transmitted by the one or more wireless devices. In previous solutions, the signal was multiplexed such that each wireless device or related user transmitted data over either an I or Q branch of the channel. Thus, each wireless device or related user was assigned to a multiplexing configuration that utilized a Walsh code for transmission over a signal channel branch (e.g., I or Q branch). It is to be appreciated that a Walsh code can refer to an orthogonal code applied to data or signals in defining communication channels. For example, Walsh codes for a channel supporting 4 signals can include [1 1 1 1], [1 −1 1 −1], [1 1 −1 −1], and [1 −1 −1 1], which can transmit over an I branch. Thus, the channel can be extended to support 8 signals by adding Walsh codes applied with a 90-degree phase rotation (e.g., multiplied by the imaginary number j=\sqrt{−1}), which can be transmitted over a Q branch.

According to subject matter described herein, the channel resource assignor 302 can allocate multiplexing configurations to wireless devices such that a given wireless device transmits a portion of a related signal (e.g., half of the signal) over the I branch and the remaining portion over the Q branch. In this regard, transmit power can be substantially similar over the branches. In one example, this can be accomplished by utilizing modified Walsh codes, described below, an M matrix, or substantially any matrix with good correlation properties. Where Walsh codes are utilized to multiplex the symbols, for example, the codes can each have I and Q branch modifiers. Thus, for example, the Walsh codes for a channel supporting 8 signals with I/Q multiplexing can include [1 1 j j], [1 −1 j −j], [1 1 −j −j], [1 −1 −j j], as well as the foregoing codes multiplied by j. Therefore, in this example, the channel resource assignor 302 can allocate one or more of the channels, and corresponding Walsh codes, to the wireless devices. The signal receiver 304 can subsequently receive signals from the wireless devices over the channels according to the assigned Walsh codes and demultiplex the signals with minimal I/Q imbalance, as the codes cause transmission over the I and Q branch for a given channel signal. In another example, signals can be distributed over multiple CCEs, or other partial time and frequency resources of a channel; in this regard, the channel resource assignor 302 can allocate CCEs such that a wireless device can transmit signals over the CCEs alternating between the I and Q branches for a given signal. In yet another example, the channel resource assignor 302 can specify a complex scrambling code to utilize for encoding the signals; the code can cause the signal to be transmitted over I and Q branches.

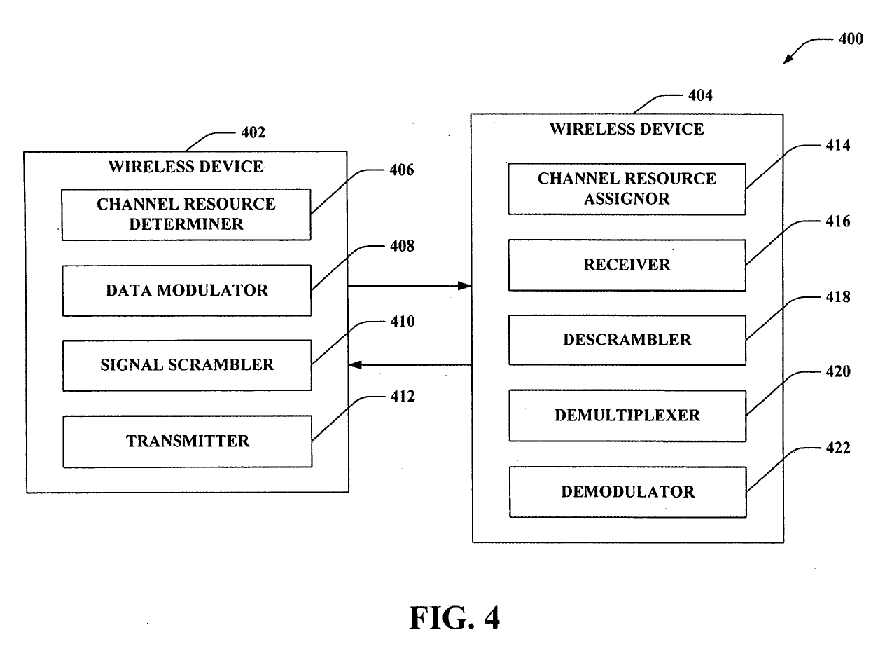

Now referring to FIG. 4, illustrated is a wireless communications system 400 that facilitates communicating using distributed I/Q multiplexed signals. Wireless device 402 and/or 404 can be a mobile device (including not only independently powered devices, but also modems, for example), a base station, and/or portion thereof. In one example, the wireless devices 402 and 404 can communicate using peer-to-peer or ad hoc technology where the devices 402 and 404 are of similar type. Moreover, system 400 can be a MIMO system and/or can conform to one or more wireless network system specifications (e.g., EV-DO, 3GPP, 3GPP2, 3GPP LTE, WiMAX, etc.). Also, the components and functionalities shown and described below in the wireless device 402 can be present in the wireless device 404 as well and vice versa, in one example; the configuration depicted excludes these components for ease of explanation.

Wireless device 402 includes a channel resource determiner 406 that can obtain information related to communicating over communications channels, a data modulator 408 that can modulate data into one or more signals to be transmitted over the communication channel, a signal scrambler 410 that can apply a scrambling sequence to one or more signals that encodes the message for protection during transmission, and a transmitter 412 that can transmit signals over the wireless communications system 400. Wireless device 404 can include a channel resource assignor 414 that can allocate communication channel resources to one or more wireless devices, such as wireless device 402, a receiver 416 that can receive one or more signals from the one or more wireless devices, a descrambler 418 that can reverse a scrambling code applied over a received signal, a demultiplexer 420 that can demultiplex a received signal to one or more individual signals, and a demodulator 422 that can demodulate a signal to produce data conveyed by the signal. It is to be appreciated that one or more of the components in the wireless devices 402 and 404 can be optional. For example, signal scrambler 410 may not be present or may not be utilized by the wireless device 402, and the presence or utilization of descrambler 418 in the wireless device 404 can depend on whether the signal scrambler 410 is present and/or utilized.

According to an example, wireless device 402 can distribute signals over an I and Q branch to facilitate substantially balanced I/Q multiplexing, as described herein. In one example, the channel resource determiner 406 can obtain one or more channel resources and/or related configuration information for transmitting signals thereover. This can be hardcoded in the wireless device 402, received from one or more network components, received from the channel resource assignor 414, and/or the like. The configuration information can relate to transmitting signals over I and Q branches of a communications channel. In one example, the information can be one or more Walsh codes, or other orthogonal or quasi-orthogonal codes, for modulating the data where at least one Walsh code has an I and a Q portion such that modulation of the data results in a portion of the data modulated on to the I branch and a portion on the Q branch, as described above.

In one example, the channel resource assignor 414 can define and allocate channel resources and/or modulation data for various wireless devices to support sharing the channel among multiple signals and thus devices. For example, the channel resource assignor 414 can use the following matrix of Walsh codes assigning each device to a column to provide orthogonal modulation of data over I and Q branches.

$$[ \begin{matrix}1 & 1 & 1 & 1 \\ j & - 1 & 1 & - 1 \\ j & j & - j & - j \\ j & - j & - j & j\end{matrix} ] for I branch ; and j [ \begin{matrix}1 & 1 & 1 & 1 \\ 1 & - 1 & 1 & - 1 \\ j & j & - j & - j \\ j & - j & - j & j\end{matrix} ] for Q branch .$$

Thus, each code represented by a column, which can be assigned to a device, applies I and Q branch properties to equalize a signal over both branches. In this example, 8 channels can be grouped for transmission as a signal from various wireless devices, including wireless device 402, to the wireless device 404. It is to be appreciated that more or less channels can be similarly grouped. For example, where a channel includes 4 groups, the following codes can be utilized.

$$[ \begin{matrix}1 & 1 \\ j & - j\end{matrix} ] for I branch ; and j [ \begin{matrix}1 & 1 \\ j & - j\end{matrix} ] for Q branch .$$

According to one example, the channel can be a control channel, such as a PHICH. In addition, the channel can relate to multiple control channels, such as multiple PHICHs, to support uplink SU-MIMO communication with multiple transport blocks. In this example, multiple PHICHs relate to a single device, such as wireless device 404, can each transmit on the I and Q branches to mitigate imbalance when communicating the multiple PHICHs to the device. Moreover, the channel Walsh codes can be constructed based on a cyclic prefix (CP) related to the channel (e.g., a PHICH with normal CP can utilize the 8 code grouping while a PHICH with extended CP can utilize the 4 code grouping).

The channel resource determiner 406 can receive such a resource assignment from the wireless device 404 (e.g., the channel resource assignor 414) including one or more orthogonal or quasi-orthogonal codes (e.g., Walsh codes) for transmitting signals over the channel, for example. In this example, the data modulator 408 can spread data over I and Q branches of the channel using the provided codes to create one or more signals for transmission. The signal scrambler 410 can apply a scrambling code to the signal, and the transmitter 412 can transmit the scrambled signal, in one example. Wireless device 404 can receive the signal along with one or more signals for/from disparate wireless devices over the I and Q branches, and the signals can appear as a multiplexed signal based on codes utilized by the devices in modulating data into the signal, in one example.

The receiver 416 can receive the multiplexed signal, for example, and the descrambler 418 can descramble the signal, if scrambled. The demultiplexer 420 can demultiplex the signal into the signals transmitted for/by the devices. In one example, the demultiplexer 420 can evaluate signals received on both the I and Q branches to determine the signals sent for/by the separate devices, such as wireless device 402. For example, the signal received over the I and Q branches can be represented as:

$$[ \begin{matrix}{y}_{1} \\ {y}_{2} \\ ⋮ \\ {y}_{M}\end{matrix} ] = h [ \begin{matrix}{w}_{1}^{1} & {w}_{2}^{1} & … & {w}_{M}^{1} \\ {w}_{1}^{2} & {w}_{2}^{2} & … & {w}_{M}^{2} \\ … & … & … & … \\ j {w}_{1}^{M - 1} & j {w}_{2}^{M - 1} & … & j {w}_{M}^{M - 1} \\ j {w}_{1}^{M} & j {w}_{2}^{M} & ... & j {w}_{M}^{M}\end{matrix} ] [ \begin{matrix}{a}_{1} \\ {a}_{2} \\ ⋮ \\ {a}_{M}\end{matrix} ] + j h [ \begin{matrix}{w}_{1}^{1} & {w}_{2}^{1} & … & {w}_{M}^{1} \\ {w}_{1}^{2} & {w}_{2}^{2} & … & {w}_{M}^{2} \\ … & … & … & … \\ j {w}_{1}^{M - 1} & j {w}_{2}^{M - 1} & … & j {w}_{M}^{M - 1} \\ j {w}_{1}^{M} & j {w}_{2}^{M} & ... & j {w}_{M}^{M}\end{matrix} ] [ \begin{matrix}{b}_{1} \\ {b}_{2} \\ ⋮ \\ {b}_{M}\end{matrix} ] + [ \begin{matrix}{n}_{1} \\ {n}_{2} \\ ⋮ \\ {n}_{M}\end{matrix} ]$$

$$\vec{y} = h ( \tilde{W} \vec{a} + j \tilde{W} \vec{b} ) + \vec{n}$$

where M is the number of channels that can be handled at each branch individually, h is the channel gain over an M×1 grid, w is the Walsh code, \vec{a} is a vector of signals transmitted over each channel on the I branch, and \vec{b} is a vector of signals transmitted over each channel on the Q branch, and \vec{n} is a vector representing the noise over each channel on both branches. In this example, with M tones, 2M channel groups are evenly distributed over I and Q branch. Thus, the demultiplexer 420 can apply channel estimation to the vector \vec{y}. Upon separating the I and Q branch, in one example, the following can represent the signals at each branch:

$$[ \begin{matrix}{r}_{1} \\ {r}_{2} \\ ⋮ \\ {r}_{M}\end{matrix} ] = {\vert h \vert}^{2} [ \begin{matrix}{w}_{1}^{1} & {w}_{2}^{1} & … & {w}_{M}^{1} \\ {w}_{1}^{2} & {w}_{2}^{2} & … & {w}_{M}^{2} \\ 0 & 0 & … & 0 \\ 0 & 0 & … & 0\end{matrix} ] [ \begin{matrix}{a}_{1} \\ {a}_{2} \\ ⋮ \\ {a}_{M}\end{matrix} ] - {\vert h \vert}^{2} [ \begin{matrix}0 & 0 & … & 0 \\ 0 & 0 & … & 0 \\ {w}_{1}^{M - 1} & {w}_{2}^{M - 1} & … & {w}_{M}^{M - 1} \\ {w}_{1}^{M} & {w}_{2}^{M} & … & {w}_{M}^{M}\end{matrix} ] [ \begin{matrix}{b}_{1} \\ {b}_{2} \\ ⋮ \\ {b}_{M}\end{matrix} ] + {h}^{*} [ \begin{matrix}{n}_{1} \\ {n}_{2} \\ ⋮ \\ {n}_{2 M}\end{matrix} ] \\ [ \begin{matrix}{g}_{1} \\ {g}_{2} \\ ⋮ \\ {g}_{M}\end{matrix} ] = {\vert h \vert}^{2} [ \begin{matrix}0 & 0 & … & 0 \\ 0 & 0 & … & 0 \\ {w}_{1}^{M - 1} & {w}_{2}^{M - 1} & … & {w}_{M}^{M - 1} \\ {w}_{1}^{M} & {w}_{2}^{M} & … & {w}_{M}^{M}\end{matrix} ] [ \begin{matrix}{a}_{1} \\ {a}_{2} \\ ⋮ \\ {a}_{M}\end{matrix} ] + {\vert h \vert}^{2} [ \begin{matrix}{w}_{1}^{1} & {w}_{2}^{1} & … & {w}_{M}^{1} \\ {w}_{1}^{2} & {w}_{2}^{2} & … & {w}_{M}^{2} \\ 0 & 0 & … & 0 \\ 0 & 0 & … & 0\end{matrix} ] [ \begin{matrix}{b}_{1} \\ {b}_{2} \\ ⋮ \\ {b}_{M}\end{matrix} ] + {h}^{*} [ \begin{matrix}{n}_{1} \\ {n}_{2} \\ ⋮ \\ {n}_{2 M}\end{matrix} ]$$

Thus, despreading using the demultiplexer 420 over

$$[ \begin{matrix}{r}_{1} \\ {r}_{2} \\ ⋮ \\ {r}_{\frac{M}{2}} \\ {g}_{\frac{M}{2} + 1} \\ ⋮ \\ {g}_{M - 1} \\ {g}_{M}\end{matrix} ]$$

yields the desired signal on first M PHICH and dispreading over

$$[ \begin{matrix}{g}_{1} \\ {g}_{2} \\ ⋮ \\ {g}_{\frac{M}{2}} \\ - {r}_{\frac{M}{2} + 1} \\ ⋮ \\ - {r}_{M - 1} \\ - {r}_{M}\end{matrix} ]$$

yields the rest M PHICH signals.
Once the signals are despread, the demodulator 422 can produce data from the signals, for example based on the utilized orthogonal or quasi-orthogonal code (e.g., Walsh code) described above. It is to be appreciated that this is just one example of distribution over the branches; distribution need not be evenly split as described, for example. It is also to be appreciated that Walsh codes need not be used; rather, an M matrix, or substantially any matrix with good correlation properties can be utilized in this regard as well, for example.

In another example, configuration information received at the channel resource determiner 406 can relate to alternating transmission of repeated signals such that at least one transmission is over the I branch and at least one is over the Q branch. For example, where the channel over which the signal is transmitted provides for repetitive transmission of the signal (e.g., more than one CCE per channel), the data modulator 408 can modulate desired data into a signal on the I branch for one transmission by the transmitter 412, the Q branch for a subsequent transmission and so on. This effectively equalizes transmission power over the I and Q branches for full transmission of the signal, in one example. Likewise in the previous example, the signal scrambler 410 can encode the signal for security, and the transmitter 412 can transmit the signal, which can be received at the receiver 416. The descrambler 418 can descramble the signal, if scrambled by a signal scrambler 410, and the demultiplexer 420 can demultiplex the received signals (e.g., using conventional methods in this example). Subsequently, the demodulator 422 can reverse the applied Walsh code to determine the data transmitted in the signal by the device, such as wireless device 402.

Moreover, in an example, the configuration information received from the channel resource determiner 406 can relate to using a complex scrambling code for the signal such that the resulting signal is on the I or Q branch. For example, the data modulator 408 can modulate data on the I branch generating a signal for transmission thereover. The signal scrambler 410 can apply a complex scrambling code that results in a portion or substantially all of the signal being transmitted over the Q branch by the transmitter 412. Distribution of the signal is possible in this regard as well to equalize or spread transmission power over the I and Q branches to mitigate I/Q imbalance. In this case, the receiver 416 can receive the I and Q branch signals, descrambler 418 can descramble the received signals using the complex scrambling code, demultiplexer 420 can separate the individual signals from the I and Q branches for demodulation 422. As described, the demodulator 422 can determine data transmitted in the signal based on a code, such as a Walsh code, utilized to spread the data over the signal. It is to be appreciated that substantially any functionality of modulating a signal on both I and Q branches is possible; the foregoing are but a few examples.

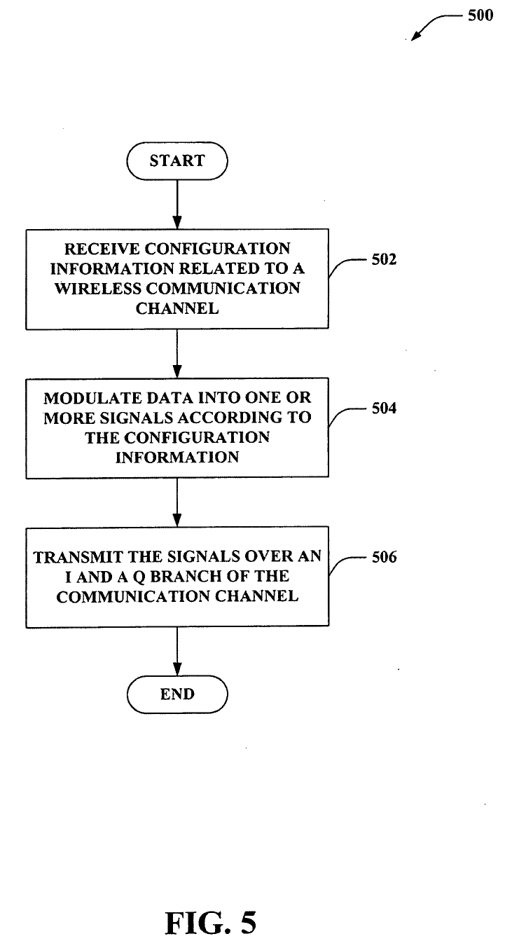

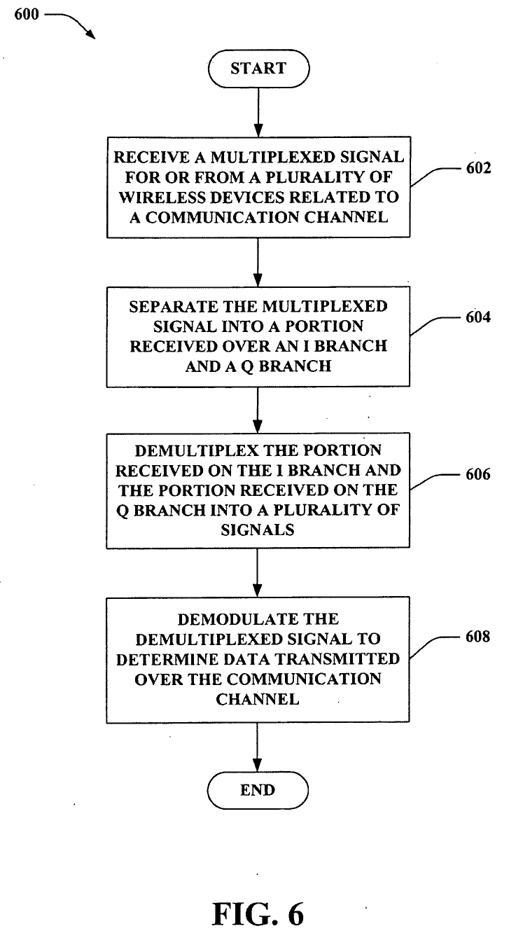

Referring to FIGS. 5-6, methodologies relating to transmitting and receiving signals using I/Q multiplexing while mitigating I/Q imbalance are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more embodiments.

Turning to FIG. 5, a methodology 500 that facilitates mitigating I/Q imbalance in transmitting over a wireless communications channel is illustrated. At 502, configuration information is received related to a wireless communication channel. For example, as described, the configuration information can relate to one or more codes or matrices with good correlation properties (e.g., Walsh codes) to facilitate orthogonal communication of signals over the channel, complex scrambling codes, transmission specifications for multiple CCE channels, etc. In this regard, the configuration information can relate to transmitting a portion of a signal over an I branch and a portion over a Q branch. At 504, data can be modulated into one or more signals according to the configuration information to mitigate I/Q imbalance, as described previously. For example, where the configuration information comprises Walsh codes, the codes can have real and complex elements such that modulating using the codes results in I and Q signals for a given set of data. Moreover, in one example, where the configuration information relates to a complex scrambling code, a portion of the signal can be scrambled on the I branch and a portion on the Q branch, as described. At 506, the signals can be transmitted over an I and Q branch of the communication channel. This can evenly spread related transmission power to mitigate I/Q imbalance, for example.

Turning to FIG. 6, illustrated is a methodology 600 that facilitates receiving data transmitted over an I and Q branch to mitigate I/Q imbalance. At 602, a multiplexed signal can be received for/from a plurality of wireless devices related to a communication channel. For example, the multiplexed signals can comprise a plurality of signals transmitted for/by various wireless devices over a communications channel. As described, for example, matrices and/or codes with good correlation properties can be used to modulate data to achieve the foregoing. At 604, the multiplexed signal can be separated into a portion received over an I branch and a portion received over a Q branch. In one example, the Q branch can be phase rotated 90-degrees compared to the I branch to allow further orthogonal transmission over the branches. At 606, the portion received over the I branch and the portion received over the Q branch can be demultiplexed into a plurality of signals, which can have been transmitted for/by a plurality of wireless devices. At 608, a demultiplexed signal from both the I branch and the Q branch can be demodulated to determine data transmitted over the communication channel for a given wireless device, for example. Thus, data is transmitted using both branches to mitigate I/Q imbalance.

It will be appreciated that, in accordance with one or more aspects described herein, inferences can be made regarding determining codes to use in modulating data, scrambling codes used to encode data, repetition schemes for transmitting data over I and Q branches in different CCEs, and/or the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

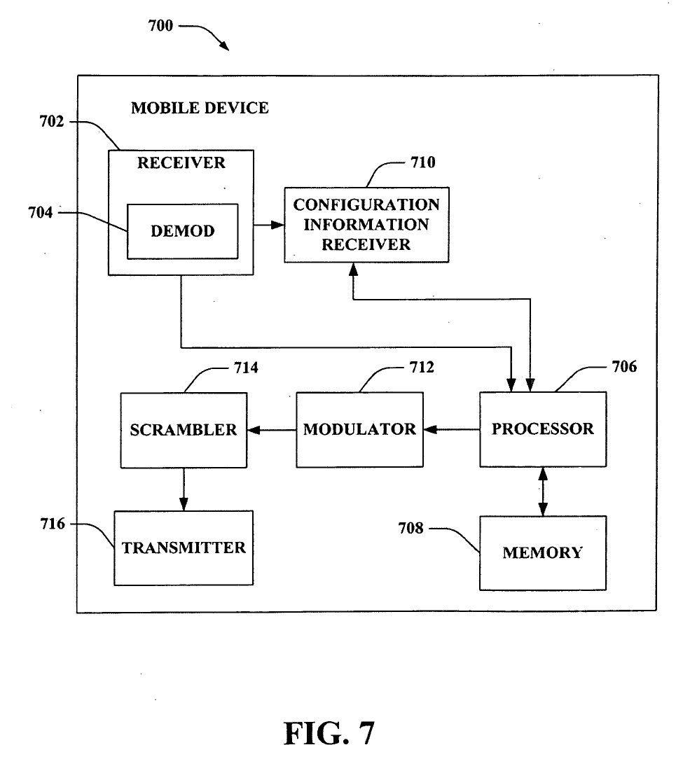

FIG. 7 is an illustration of a mobile device 700 that facilitates transmitting signals over an I and Q branch of a channel. Mobile device 700 comprises a receiver 702 that receives one or more signals over one or more carriers from, for instance, a receive antenna (not shown), performs typical actions on (e.g., filters, amplifies, downconverts, etc.) the received signals, and digitizes the conditioned signals to obtain samples. Receiver 702 can comprise a demodulator 704 that can demodulate received symbols and provide them to a processor 706 for channel estimation. Processor 706 can be a processor dedicated to analyzing information received by receiver 702 and/or generating information for transmission by a transmitter 716, a processor that controls one or more components of mobile device 700, and/or a processor that both analyzes information received by receiver 702, generates information for transmission by transmitter 716, and controls one or more components of mobile device 700.

Mobile device 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 708 of the subject systems and methods is intended to comprise, without being limited to, these and any other suitable types of memory.

The processor 706 can further be operatively coupled to a configuration information receiver 710 that can obtain parameters related to transmitting data over a wireless network. For example, as described, the configuration information can relate to codes and/or matrices that can be utilized to generate signals from data where the resulting signals are transmitted on both an I and Q branch of a communication channel. Mobile device 700 still further comprises a modulator 712 that can modulate data into signals based on the configuration information, as described. For example, the modulator 712 can apply the codes and/or matrices (e.g., Walsh codes or other codes/matrices with good correlation properties) to the data to generate the signals.

In addition, the mobile device 700 can comprise a scrambler 714 that can encode the signals for secure transmission thereof. As described, for example, the scrambler 714 can utilized a complex scrambling code to additionally or alternatively cause transmission of a portion of the signal over an I branch and a remaining portion over a Q branch. The mobile device also comprises a transmitter 716 that transmit the signals to, for instance, a base station, another mobile device, etc. Although depicted as being separate from the processor 706, it is to be appreciated that the demodulator 704, configuration information receiver, modulator 712, and/or scrambler 714 can be part of the processor 706 or multiple processors (not shown).

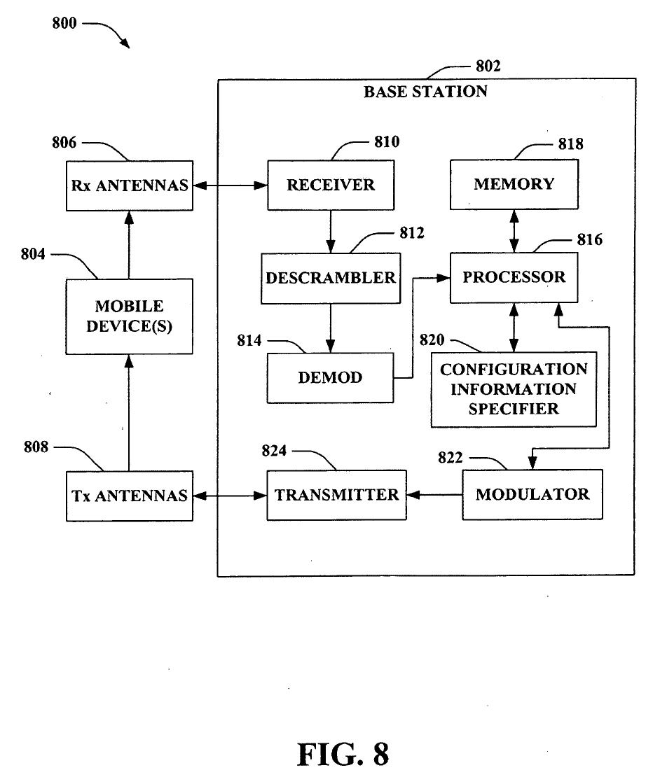

FIG. 8 is an illustration of a system 800 that facilitates receiving signals from a mobile device over an I and Q branch of a communication channel. The system 800 comprises a base station 802 (e.g., access point, . . . ) with a receiver 810 that receives signal(s) from one or more mobile devices 804 through a plurality of receive antennas 806, and a transmitter 824 that transmits to the one or more mobile devices 804 through a transmit antenna 808. Receiver 810 can receive information from receive antennas 806 and is operatively associated with a descrambler that can decode received signals. Furthermore, demodulator 814 can demodulate received descrambled signals. Demodulated symbols are analyzed by a processor 816 that can be similar to the processor described above with regard to FIG. 7, and which is coupled to a memory 818 that stores information related to estimating a signal (e.g., pilot) strength and/or interference strength, data to be transmitted to or received from mobile device(s) 804 (or a disparate base station (not shown)), and/or any other suitable information related to performing the various actions and functions set forth herein. Processor 816 is further coupled to a configuration information specifier 820 that can assign channel configuration information to one or more mobile devices 804 and transmit the information thereto.

According to an example, the descrambler 812 can decode signals received over an I and a Q branch to produce a single signal for demodulation. In another example, the demodulator 814 can demodulate signals received over an I and Q branch to determine data from a mobile device 804. The configuration information specifier 820 can transmit configuration information to the mobile devices 804 to compel the mobile devices 804 to utilize the I and Q branch in transmitted/received. As described, transmitting data for/from a device over an I and Q branch can distribute transmission power over the branches to mitigate I/Q imbalance. Furthermore, although depicted as being separate from the processor 816, it is to be appreciated that the demodulator 814, descrambler 818, configuration information specifier 820, and/or modulator 822 can be part of the processor 816 or multiple processors (not shown).

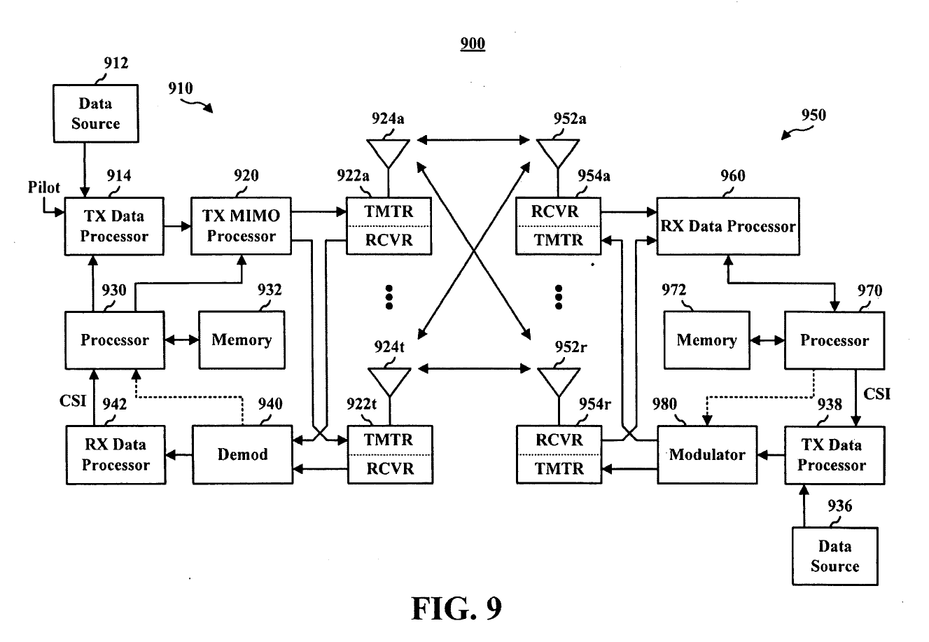

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. In addition, it is to be appreciated that base station 910 and/or mobile device 950 can employ the systems (FIGS. 1-4 and 7-8) and/or methods (FIGS. 5-6) described herein to facilitate wireless communication there between.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g. symbol mapped) based on a particular modulation scheme (e.g., BPSK, QPSK, M-PSK, M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides N_{T} modulation symbol streams to N_{T} transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g. amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 can periodically determine which preceding matrix to utilize as discussed above. Further, processor 970 can formulate a reverse link message comprising a matrix index portion and a rank value portion.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining the beamforming weights.

Processors 930 and 970 can direct (e.g., control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

It is to be understood that the embodiments described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

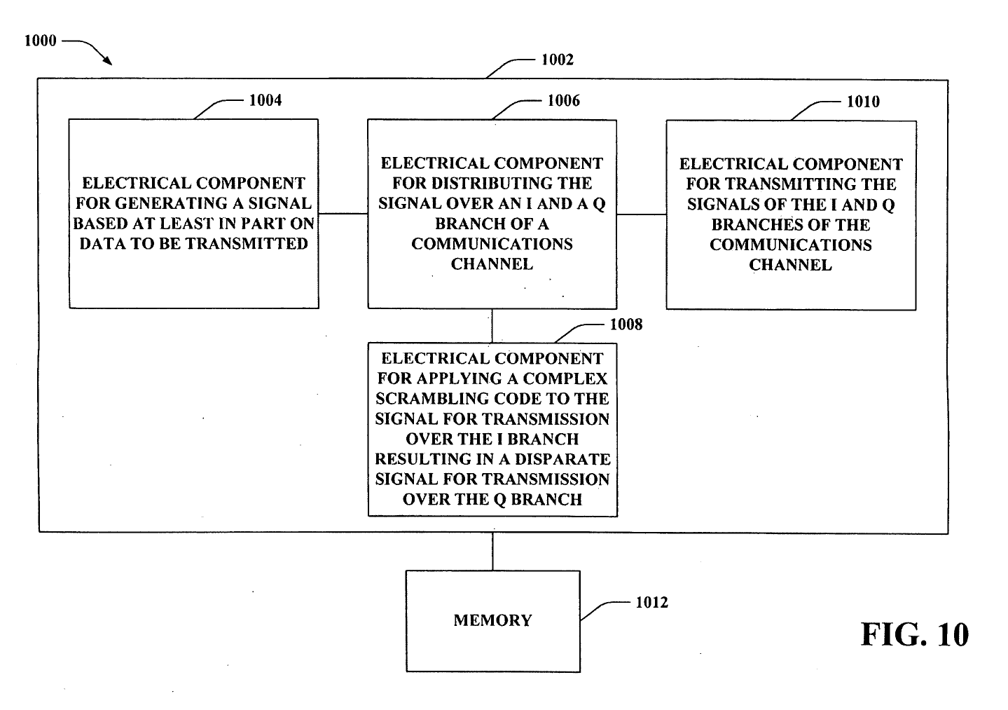

With reference to FIG. 10, illustrated is a system 1000 that transmits signals over an I and Q branch to distribute power over the branches, thus decreasing I/Q imbalance. For example, system 1000 can reside at least partially within a base station, mobile device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. For instance, logical grouping 1002 can include an electrical component for generating a signal based at least in part on data to be transmitted 1004. For example, the signal can be generated by modulating the data using a code or matrix with good correlation properties, such as a Walsh code, etc. In another example, using a repetitive transmission technology, a signal can be transmitted over the I branch followed by one over the Q branch, as described supra. Further, logical grouping 1002 can comprise an electrical component for distributing the signal over an I and Q branch of a communications channel 1006. In this regard, the signal can be balanced or distributed with power over both the I and Q branches to mitigate I/Q imbalance, as described. In one example, the code or matrix provided to modulate the data can comprise real and complex modifiers to facilitate this behavior, as described.

Furthermore, logical grouping 1002 can include an electrical component for applying a complex scrambling code to the signal for transmission over the I branch resulting in a disparate signal for transmission over the Q branch 1008. Thus, for example, the scrambling code can additionally or alternatively be utilized to generate a signal that is transmitted over the I and Q branches. In addition, logical grouping 1002 can also comprise an electrical component for transmitting the signals of the I and Q branches of the communications channel 1010. Since the signal, and hence the signal power, are transmitted over both branches, I/Q imbalance can be mitigated, as described. Additionally, system 1000 can include a memory 1012 that retains instructions for executing functions associated with electrical components 1004, 1006, 1008, and 1010. While shown as being external to memory 1012, it is to be understood that one or more of electrical components 1004, 1006, 1008, and 1010 can exist within memory 1012.

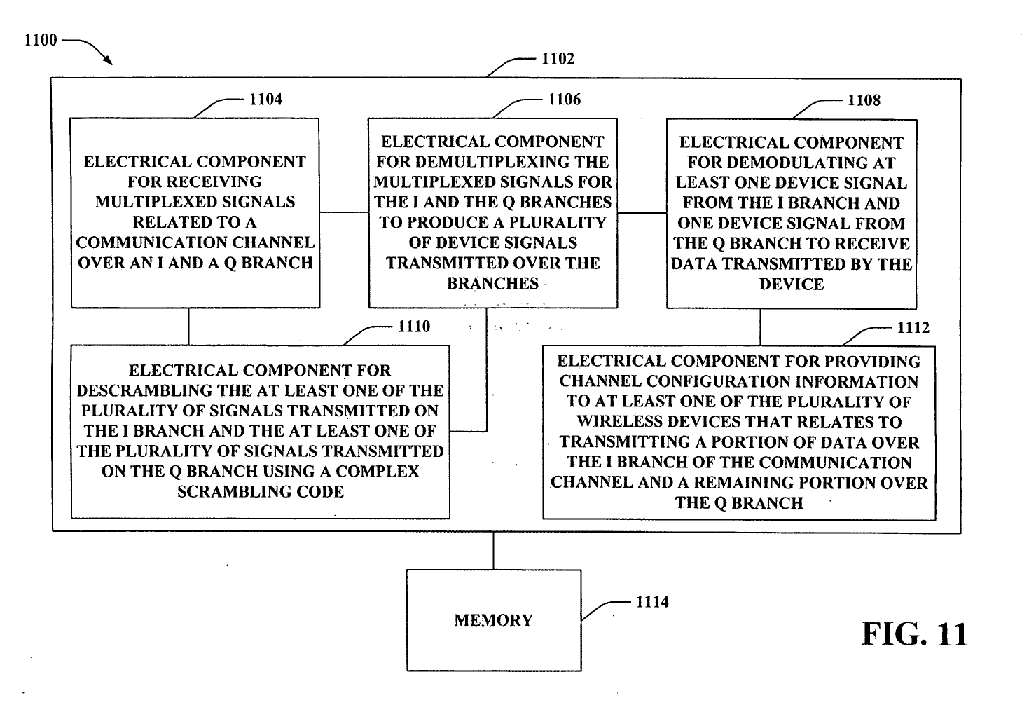

Turning to FIG. 11, illustrated is a system 1100 that receives signals transmitted over I and Q branches of a communication channel. System 1100 can reside within a base station, mobile device, etc., for instance. As depicted, system 1100 includes functional blocks that can represent functions implemented by a processor, software, or combination thereof (e.g. firmware). System 1100 includes a logical grouping 1102 of electrical components that receive and interpret signals to determine data transmitted by the signals. Logical grouping 1102 can include an electrical component for receiving multiplexed signals related to a communication channel over an I and a Q branch 1104. The multiplexed signals can comprise signals for/from various wireless devices transmitted/received so multiplexed signals are received to facilitate orthogonal communication. Moreover, logical grouping 1102 can include an electrical component for demultiplexing the multiplexed signals for the I and Q branches to produce a plurality of device signals transmitted over the branches 1106. For example, the device signals can be split among the I and Q branches such that a signal for a given device has both I and Q portions. In this regard, logical grouping 1102 can also include an electrical component for demodulating at least one device signal from the I branch and one device signal from the Q branch to receive data transmitted by the device 1108. Since the signals can be transmitted in this manner, I/Q imbalance can be mitigated as signal power for a given device is distributed over the I and Q branches.

Furthermore, logical grouping 1102 can include an electrical component for descrambling the at least one device signal transmitted on the I branch and the at least one device signal transmitted on the Q branch using a complex scrambling code 1110. This electrical component 1110 can be utilized before demultiplexing the signal, as described herein, where the received signal is scrambled. Thus, where a scrambling code was utilized to distribute the signal over the I and Q branches, electrical component 1110 can reverse the code to produce the device signal for demultiplexing. Also, logical grouping 1102 can include an electrical component for providing channel configuration information to at least one wireless device that relates to transmitting a portion of data over the I branch of the communication channel and a remaining portion over the Q branch 1112. The wireless device can utilize this configuration information, as described above, in transmitting signals over the wireless network. Additionally, system 1100 can include a memory 1114 that retains instructions for executing functions associated with electrical components 1104, 1106, 1108, 1110, and 1112. While shown as being external to memory 1114, it is to be understood that electrical components 1104, 1106, 1108, 1110, and 1112 can exist within memory 1114.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

What is claimed is:

1. A method for modulating data for in-phase/quadrature (I/Q) multiplexing, comprising:
receiving configuration information related to a wireless communication channel;
modulating data into one or more signals according to the configuration information; and
transmitting the signals over an I and a Q branch of the communication channel.

2. The method of claim 1, wherein modulating the data includes mapping a portion of the data for transmission over the I branch and a remaining portion of the data over the Q branch.

3. The method of claim 2, wherein the portion of the data for transmission over the I branch is substantially half of the data.

4. The method of claim 2, wherein the configuration information comprises one or more orthogonal or quasi-orthogonal codes for modulating the data.

5. The method of claim 4, wherein the orthogonal or quasi-orthogonal codes include a real portion and a complex portion.

6. The method of claim 2, wherein the portion of data mapped for transmission over the I branch corresponds to a first control channel that supports multiple-input multiple-output (MIMO) communication with multiple transport blocks to a device and data mapped for transmission over the Q branch corresponds to a disparate control channel related to the first control channel.

7. The method of claim 1, wherein the signals are repeatedly transmitted over a plurality of partial time and frequency resources related to the communication channel.

8. The method of claim 7, wherein transmitting the signals includes alternating transmission over the I and Q branches for a given partial time and frequency resource.

9. The method of claim 1, wherein the configuration information relates to a complex scrambling code for encoding the signals.

10. The method of claim 9, further comprising scrambling the signals using the complex scrambling code to facilitate transmitting the signals over the I and Q branch of the communication channel.

11. A wireless communications apparatus, comprising:
at least one processor configured to:
create a signal for transmission based at least in part on received data;
distribute the signal over an I and a Q branch of a communication channel; and
transmit the signal over the communication channel using the I and Q branches; and
a memory coupled to the at least one processor.

12. A wireless communications apparatus that facilitates mitigating I/Q imbalance in transmitting wireless communication signals, comprising:
means for generating a signal based at least in part on data to be transmitted;
means for distributing the signal over an I and a Q branch of a communications channel; and
means for transmitting the signals of the I and Q branches of the communications channel.

13. A computer program product, comprising:
a computer-readable medium comprising:
code for causing at least one computer to determine configuration information related to a communication channel;
code for causing the at least one computer to modulate data into one or more signals divided over an I and a Q branch of the communication channel; and
code for causing the at least one computer to transmit the signals over the I and Q branches of the communication channel.

14. An apparatus, comprising:
a channel resource determiner that receives configuration information related to one or more communication channels;
a data modulator that generates a signal for transmission over an I branch and a signal for transmission over a Q branch of the channel based at least in part on the configuration information; and
a transmitter that transmits the signals over the I and Q branch.

15. The apparatus of claim 14, wherein the configuration information comprises a plurality of codes and the data modulator applies the codes to data to generate the signal for transmission over the I branch and the signal for transmission over the Q branch.

16. The apparatus of claim 15, wherein the codes are one or more orthogonal or quasi-orthogonal codes to facilitate simultaneous transmission of the signals.

17. The apparatus of claim 15, wherein the signal for transmission over the I branch relates to a portion of the data and the signal for transmission over the Q branch relates to a remaining portion of the data.

18. The apparatus of claim 15, wherein the signal for transmission over the I branch comprises substantially all of the data and the signal transmitted over the Q branch comprises substantially all of the data.

19. The apparatus of claim 18, wherein the transmitter transmits the signal for transmission over the I branch in a partial time and frequency resource related to the communication channel and transmits the signal for transmission over the Q branch in a disparate partial time and frequency resource related to the communication channel.

20. The apparatus of claim 14, wherein the configuration information relates to a complex scrambling code to encode the signal for transmission over the I branch.

21. The apparatus of claim 20, further comprising a signal scrambler that applies the complex scrambling code to the signal for transmission over the I branch resulting in a disparate signal for transmission over the Q branch.

22. A method that facilitates evaluating communication channels based on a signal multiplexed over an I and Q branch, comprising:
receiving a multiplexed signal from a plurality of wireless devices related to a communication channel;
separating the multiplexed signal to a portion received at an I branch and a portion received at a Q branch; and
demodulating part of the portion received at the I branch and part of the portion received at the Q branch to produce data transmitted by one of the plurality of wireless devices over the communication channel.

23. The method of claim 22, further comprising descrambling the part of the portion received at the I branch and the part of the portion received at the Q branch using a complex scrambling code.

24. The method of claim 22, wherein the demodulating is performed using an orthogonal or quasi-orthogonal code having real and complex properties.

25. The method of claim 22, further comprising assigning channel resources to at least one of the plurality of wireless devices wherein the channel resources include channel configuration information related to transmitting a portion of channel data over and I branch and a remaining portion over a Q branch.

26. The method of claim 25, wherein the channel configuration information relates to one or more orthogonal or quasi-orthogonal codes having real and complex parameters.

27. The method of claim 25, wherein the channel configuration information relates to a complex scrambling code for encoding data transmitted over the channel.

28. The method of claim 25, wherein the portion received at the I branch corresponds to a first control channel that supports multiple-input multiple-output communication and the portion received at the Q branch corresponds to a disparate control channel related to the first control channel.

29. A wireless communications apparatus, comprising:
at least one processor configured to:
receive a multiplexed signal from a plurality of wireless devices over a communication channel;
demultiplex the multiplexed signal to determine a plurality of signals each related to at least one of the plurality of wireless devices transmitted over an I and a Q branch of the communication channel; and
demodulate at least one signal transmitted over the I branch and one signal transmitted over the Q branch to determine data transmitted by at least one of the plurality of wireless devices; and
a memory coupled to the at least one processor.

30. A wireless communications apparatus for receiving I/Q multiplexed signals, comprising:
means for receiving multiplexed signals related to a communication channel over an I and a Q branch;
means for demultiplexing the multiplexed signals for the I and the Q branches to produce a plurality of signals from a device transmitted over the branches; and
means for demodulating at least one device signal from the I branch and one device signal from the Q branch to receive data transmitted by the device.

31. A computer program product, comprising:
a computer-readable medium comprising:
code for causing at least one computer to receive a multiplexed signal from a plurality of wireless devices related to a communication channel;
code for causing the at least one computer to separate the multiplexed signal to a portion received at an I branch and a portion received at a Q branch; and
code for causing the at least one computer to demodulate part of the portion received at the I branch and part of the portion received at the Q branch to produce data transmitted by one of the plurality of wireless devices over the communication channel.

32. An apparatus, comprising:
a receiver that receives a multiplexed signal from a plurality of wireless devices related to a communication channel;
a demultiplexer that demultiplexes an I and a Q branch of the communication channel to yield a plurality of signals transmitted on both the I and the Q branch; and
a demodulator that demodulates at least one of the plurality of signals transmitted on the I branch and at least one of the plurality of signals transmitted on the Q branch to determine data transmitted by one of the plurality of wireless devices.

33. The apparatus of claim 32, further comprising a descrambler that descrambles the at least one of the plurality of signals transmitted on the I branch and the at least one of the plurality of signals transmitted on the Q branch using a complex scrambling code.

34. The apparatus of claim 32, wherein the demodulator demodulates using one or more orthogonal or quasi-orthogonal codes.

35. The apparatus of claim 32, further comprising a channel resource assignor that provides channel configuration information to at least one of the plurality of wireless devices wherein the configuration information relates to transmitting a portion of data over the I branch of the communication channel and a remaining portion over the Q branch of the communication channel.

36. The apparatus of claim 35, wherein the channel configuration information relates to one or more orthogonal or quasi-orthogonal codes having real and complex parameters.

37. The apparatus of claim 35, wherein the channel configuration information relates to a complex scrambling code for encoding data transmitted over the channel.
